(19) United States
(12) Patent Application Publication
(10) Pub. No.: US 2014/0373806 A1
(43) Pub. Date: Dec. 25, 2014

(54) FUEL INJECTOR FOR MULTI-FUEL INJECTION WITH PRESSURE INTENSIFICATION AND A VARIABLE ORIFICE

(71) Applicants: Deyang Hou, Sugar Land, TX (US); QuantLogic Corporation, Sugar Land, TX (US)

(72) Inventor: Deyang Hou, Sugar Land, TX (US)

(21) Appl. No.: 14/370,257

(22) PCT Filed: Dec. 7, 2012
(86) PCT No.: PCT/US2012/068584

§ 371 Date: Jul. 2, 2014

Related U.S. Application Data
(60) Provisional application No. 61/583,577, filed on Jan. 5, 2012.

(51) Int. Cl. F02M 43/04; F02B 17/00

(52) U.S. Cl. CPC F02M 43/04; F02B 17/005
USPC 123/294

(57) ABSTRACT

A multi-fuel injector has an internal pressure intensifier which has means to intensify fuels with different viscosities, cetane or octane numbers, with high viscosity fuel being used to intensify both itself and low viscosity fuels to high pressure for direct injection into combustion chamber. A combustion method using such a method of fuel injection is also disclosed. A multi-fuel injector with variable orifice nozzle and variable spray patterns is also disclosed.

### CROSS REFERENCE TO RELATED APPLICATION

This is a submission to enter US national stage under 35 U.S.C. 371 for PCT/US 12/68584, which was filed on Dec. 7, 2012 and claimed the priority of U.S. Provisional Application 61/583,577, filed on Jan. 5, 2012. The contents of 61/583,577 have been incorporated herein.

### TECHNICAL FIELDS

This invention related to a fuel injector and method of direct fuel injection for multiple fuels, especially for internal combustion engines.

### BACKGROUND OF THE INVENTION

Description of the Related Art—The combustion process in a conventional direct injection Diesel engine is characterized by diffusion combustion with a fixed-spray-angle multi-hole fuel injector. Due to its intrinsic non-homogeneous characteristics of fuel-air mixture formation, it is often contradictory to simultaneously reduce soot and NOx formation in a conventional diesel engine. Progress has been made in recent years for advanced combustion modes, such as Homogeneous-Charge Compression-Ignition (HCCI) combustion and Premixed Charge Compression Ignition (PCCI). However, many issues remain to be solved to control the ignition timing, the duration of combustion, the heat release rate of combustion for HCCI and PCCI engines for various load conditions. It seems to be a more viable solution to operate engine in mixed-mode combustion, or in HCCI mode or partially premixed mode at low to medium loads, and in conventional diffusion combustion mode at high loads for the near future. Or, we can use mixed-mode combustion even in same power cycle, such as proposed by the inventor in U.S. patent application Ser. No. 12/143,759.

A key challenge for mixed-mode combustion with conventional fix-angle multi-hole nozzle is surface wetting for early injections. There are many inventions (for example, PCT/EP2005/054057) could provide dual spray angle multiple jets spray patterns with smaller angle for early injections and larger spray angle for main injections. However, researchers find that, even with smaller jets for very earlier injections, the conventional multiple jets spray still tend to wet the piston top and thus could cause emission issues such as hydrocarbon and mono-dioxide (SAE paper 2008-01-2400). This observation especially tends to be true for passenger car engines where cylinder diameter is small.

A high pressure injection at late cycle could potentially eliminate the wall wetting while ensuring fine atomization with conventional nozzles.

To reduce carbon dioxide emissions, bio-fuels production such as ethanol and biodiesels have increased. Researchers have found that using ethanol with diesel fuel can reduce both soot and nitride oxide emissions. Currently, most ethanol-diesel dual fuel applications are practiced with one type of fuel injected in intake ports, another type of fuel injected into cylinder directly, with a different set of fuel injectors for each fuel. Injecting both bio-fuel and diesel fuel directly into cylinder with a single injector capable of dual fuel injection could potentially cut the complexity and cost of the fuel system, and further leverage the benefits of different fuel properties for optimizing combustion.

Low temperature combustion (LTC) becomes one of the most promising near term strategy to improve engine efficiency and lower emissions. Thus LTC sparks major R&D efforts among industries and academia. The LTC produces improved thermal efficiency due to reduced thermal loss and provides lower emissions of NOx and PM.

Currently, there are two major approach of using gasoline/ethanol on a diesel engine platform: intake port injection of gasoline/ethanol, and direct injection of blended gasoline/ethanol with diesel fuel. Most recently, researchers have conducted extensive research work through combing port injection of gasoline/ethanol and direct injection of diesel fuel on a diesel engine platform, and demonstrated an impressive efficiency improvement. While port injection of gasoline/ethanol only demands low pressure gasoline fuel injection systems, engine experiment data also demonstrated high HC and CO emissions. Blending gasoline/ethanol with diesel for direct injection seems promising but comes with the concerns for the durability of diesel fuel injection equipments.

We can anticipate that, with on-demand direct injection of dual-fuel gasoline or ethanol-diesel, we can eliminate issues related port injection of gasoline/ethanol, such as high HC, CO and cold starting difficulties, etc. It is also expected to significantly extend the BMEP with high pressure direct injections of both diesel and gasoline fuels.

Due to lacking a practical dual-fuel injector for direct injection applications, on-demand separately direct injection of both gasoline/ethanol and diesel fuel without pre-blending is rare in literature. However, direct injection is considered as most promising.

Conventional direct fuel injections for low viscosity fuels such as gasoline and ethanol can only be done through early injection using relatively low pressure generally below 200 bars, and this is sufficient for most direct injection gasoline engines due to the low compression ratios. However, to further explore high efficiency combustion using low viscosity fuels on diesel platform with high compression ratios without knocking concerns, further high pressure late cycle injection is needed even for gasoline or ethanol fuels.

A single injector with multi-fuel or dual fuel high pressure injection can eliminate the need for two set of fuel injectors dedicated for each fuel, thus improve simplicity and reduce the overall cost of the dual fuel engine platform. Dual fuel direct injection can also eliminate the difficulty of cold starting, and issues related to port injection and fuel blending.

### SUMMARY OF THE INVENTION

Thus, it is our goal of this invention to leverage different fuel properties and fuel pressure intensifications to:
1. use diesel fuel or other high viscosity fuels as a pressure intensifying fuel for enabling high pressure injection of low viscosity fuels, such as gasoline, ethanol, LNG;
2. use diesel fuel as a lubricant for sliding surfaces for injection of low viscosity fuels.
3. use low pressure pump for supplying gasoline or other low viscosity fuels, use a novel internal pressure intensifier within injector to significantly boost the pressure of gasoline, with a capability to reach 2000 bar gasoline injection, this is made viable through using diesel fuel as lubricant for key sliding surfaces;
4. the high injection pressure capability enables higher compression ratio and late injection, thus reduces the concerns of engine knocking, reduces carbon monoxide and hydrocarbon emission, extends the Brake Mean Effective Pressure (BMEP) map of low temperature combustion; this also enables the converging of gasoline and diesel engine base platforms;
5. use diesel fuel as an ignition improver for gasoline or other high octane number fuels, this conquers light load and cold starting issues;

The above and following discussions, whenever being focused on gasoline-diesel, should be considered as extendable to other low viscosity fuel such as ethanol, LNG, etc, and high viscosity fuels such as bio-diesel, JP-8, etc, with appropriate customizations.

### BRIEF DESCRIPTION OF THE DRAWINGS

FIG. 1 is a cross-sectional view of a first exemplary embodiment of an injector of the invention, referred as multi-fuel common rail injector, when the needle is at seating position, no fuel is being injected;

FIG. 2 is same as FIG. 1, except with the nozzle needle being at lifted position, with fuel being injected.

FIG. 3 is same as FIG. 2, except only key component being marked.

FIG. 4 is an simplified illustration of the intensification plunger with different face areas and fuel combinations.

FIG. 5(a) is an illustration of the nozzle needle being used for the one type of injector, referred as multi-fuel common rail injector; (b) is an illustration of the nozzle needle being used for the one type of injector, referred as multi-fuel unit injector;

FIG. 6 is a cross-sectional view of a second exemplary embodiment of an injector of the invention, referred as multi-fuel unit injector, with only one electronic control valve for pressure intensifier, with a passive nozzle and needle being at lifted position, with fuel being injected.

FIG. 7 is a cross-sectional view of a third exemplary embodiment of an injector of the invention, referred as multi-fuel common rail injector with a variable orifice, when the needle is at seating position, no fuel is being injected;

FIG. 8 is same as FIG. 7, except the needle is at small lift position, fuel is being injected in hollow conical spray patterns;

FIG. 9 is same as FIG. 7, except the needle is at further lifted position, fuel is being injected in both hollow conical spray patterns and multiple jets;

FIG. 10 is same as FIG. 7, except the needle is at full lift position, fuel is being injected in multiple jets while hollow conical sprays being blocked;

FIG. 11 is a cross-sectional view of a fourth exemplary embodiment of an injector of the invention, referred as multi-fuel unit injector with a variable orifice, when the needle is at further lifted position, fuel is being injected in both hollow conical spray patterns and multiple jets;

FIG. 12 is a cross-sectional view of a variable orifice nozzle with a needle tip shield for another embodiment of an injector of the invention at different states, (a) needle at seating position, (b) needle at small lift, (c) needle at further lift, (d) needle at full lift.

In all the figures,
100—combustion chamber; 200—fuel sprays;
1000—nozzle assembly; 2000—nozzle needle lift control chamber; 3000—needle control electronic valve; 4000—pressure intensifier; 5000—electronic control valve for pressure intensifier;
1—nozzle; 2—needle; 3—injector body cap; 4—needle control chamber and spring holder; 5—0-ring; 6—needle lift control spring; 7—adaptor; 8—connector; 9—check valve for low viscosity fuel; 10—pressure intensifier holder;
11—pressure intensifier plunger; 12—pressure intensifier piston spring;
13—pressure intensifier piston; 14—solenoid control valve body;
15—common rail for high viscosity fuel; 16—electrical wires;
17—solenoid for pressure intensifier; 18—spring for solenoid valve plunger;
19—solenoid plunger valve; 20—fuel supply passage in plunger valve;
21—intensifying chamber;
101, 102, 103—fuel passages for pressured high viscosity fuel;
1011—pressure intensifier inner sliding surface in contact with high viscosity fuel;
1012—pressure intensifier inner sliding surface next to low viscosity fuel;
1013—pressure intensifier inner sliding surface;
1031—fuel passage inside spring holder;
1032—fuel passage inside the nozzle;
1033—fuel passage inlets inside the needle;
1034—fuel passage along center of the needle;
1035—needle fuel passage outlets;
1036, 1037, 1038—high pressure fuel passages;
1039—annular variable orifice for variable orifice nozzle;
1040—first type of fuel in hollow conical spray; 1041—second type of fuel in hollow conical spray;
104—spent fuel passage; 105—fuel passage in nozzle;
110, 111—fuel passages of high viscosity fuel leading to intensification chamber 22;
112—high pressure fuel outlet from intensification chamber 22;
1102—lower outer cylindrical surface of plunger 11;
22—pressure intensification chamber for high viscosity fuel;
23—low viscosity fuel rail or reservoir;
2301—fuel passage connected to pressure intensification chamber 24;
2302—fuel passage connected to nozzle;
2303—fuel passage connected to low viscosity fuel reservoir;
24—low viscosity fuel intensification chamber;
25—needle sliding surface; 26—pressure chamber in nozzle; 27—nozzle sealing surface;
28—nozzle fuel multihole outlets;
2801—first type of fuel in multijet spray; 2802—second type of fuel in multijet spray;
29—needle tip shield; 31, 32, 33—needle control solenoid valve components, 31—solenoid, 32—plunger valve, 33—spring;
34—check ball for needle lift control; 35—needle control chamber seal ring;
41—check valve for high viscosity fuel;
501—needle control pressure chamber; 502—needle control fuel release passage;
503—spent fuel passage;

### DETAILED DESCRIPTION OF THE PREFERRED EMBODIMENTS

The following sections give a detailed discussion related to general fuel injection methods of this invention.

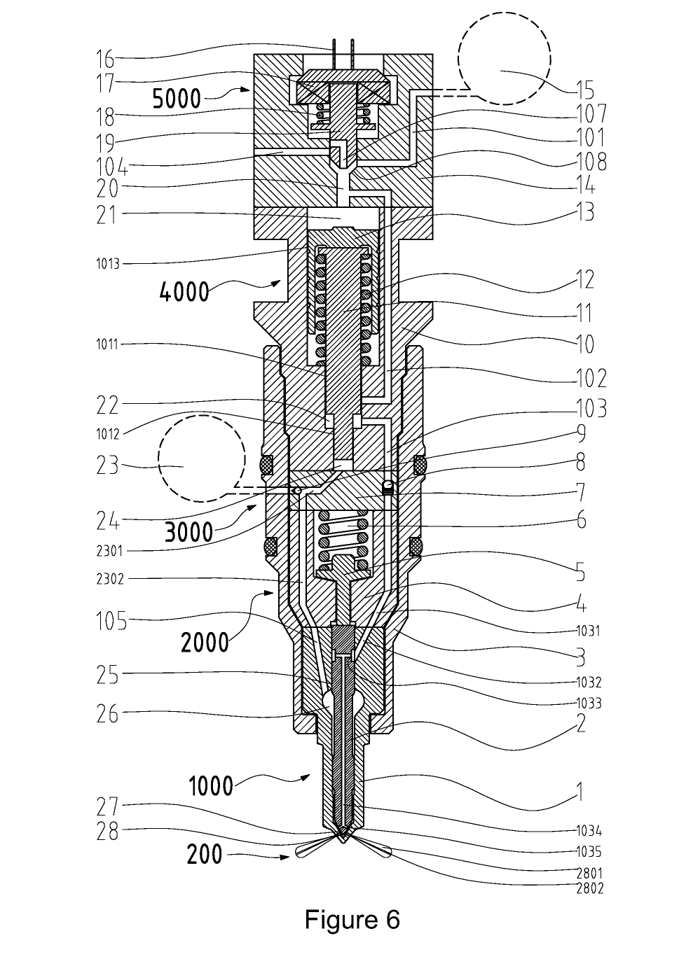

Referring to FIG. 6, low pressure gasoline flow into the fuel injector from a low pressure fuel rail (23) through fuel passage (2301) and is filled in the pressure intensification chamber (24). When the solenoid valve (17) is turned on, the control valve plunger (19) was lifted, high pressure diesel fuel or other high viscosity fuel from common rail (15) flows into intensifying chamber (21), diesel fuel is also filled in the diesel intensification chamber (22) through passage (102) and is guided through fuel passages (103, 1031, 1032, 1033) to needle tip along the fuel passage in needle center (1034) and needle small fuel passage or needle orifice (1035), at the same time, pressure intensifier piston (13) and intensifier plunger (11) are intensified and are pushed downward quickly, both the gasoline and diesel fuel in the intensification chambers (22, 24) are pressurized. The check valve (9) blocks out gasoline backward flow, the gasoline pressure in nozzle chamber (26) raises. The elevated pressure of gasoline fuel lifts the nozzle needle (2), fuel injection begins with major gasoline fuel starts first, followed by diesel injection (can be designed vice versa). After metering the desired injection fuel quantity based on pulse-width map, the solenoid valve (17) closes, thus it closes the control valve (19), partial fuel from intensifying chamber (21) flows into low pressure fuel passage (104) through fuel passage (20, 107), the pressure in the intensifying chamber (21) reduces. The pre-pressed plunger spring (12) pushes back the intensifier piston (13) to top stop position, the pressure in nozzle (1) is reduced. The spring (6) above the nozzle needle (2) conquers the reduced pressure in nozzle, the needle (2) returns to seat, fuel injection ends.

The fuel circuit for diesel fuel can be designed such that only intensification can trigger the needle lift. It is also designed such that there is an injection phase delay for diesel fuel than gasoline fuel (vice versa can be done too). In another word, fuel injection starts with major gasoline fuel and ends with fuels containing major diesel fuel for ignition purpose. The diesel fuel simultaneously serves as lubricant for the plunger and nozzle needle sliding surfaces (1011, 1012, 1013, 25) and needle seat (27), and intensification fuel for pressure intensifier (4000). This eliminates concerns about the wearing of the nozzle due to low viscosity of gasoline or other low viscosity fuels. This simple lubrication concept is fundamentally important to ensure durability and thus make it viable for the high pressure injection of gasoline fuel, which otherwise may not be possible. The integrated triple rules for diesel fuel—lubricant, intensification, and ignition improver, are the key innovative design concepts to enable a high pressure injection event for low viscosity gasoline/ethanol fuels without durability and ignition concerns.

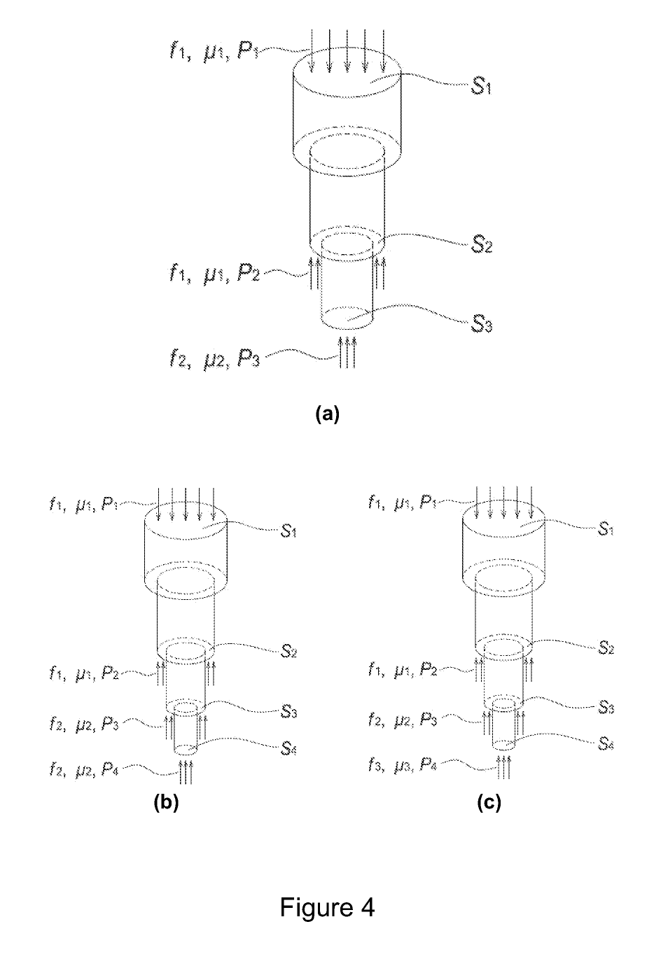

By switching the supply line of gasoline and diesel through a 2-way solenoid valve, the multi-fuel injector can be a single fuel injector with fuel injection modulated at different pressure level. By different configurations for the pressure intensifier area ratios as shown in FIG. 4, and materials, the injector can be customized for different dual-fuel/multi-fuel combinations, including gasoline-diesel, ethanol-diesel, ethanol-biodiesel, LNG-diesel, etc. The disclosed injector design is highly modular and adaptable.

With right selection of materials and intensification ratios, the injector can inject fuels with up to 3000 bar pressure, further increasing pressure is possible. For example, with common rail pressure setting at 1000 bar, a pressure intensifier intensification ratio of 3, the pressure at nozzle tip is close to 3000 bar. This performance is difficult to accomplish with conventional common rail system. Thus, the innovation proposed here, can provide high pressure injection of low viscosity fuels, and open new advanced engine combustion regimes.

For applications, most engine loads will demand an injection pressure much less. For light duty driving cycles, the diesel common rail pressure is expected to be set at 100-300 bar, which will produce a nozzle tip injection pressure by the pressure intensifier to about 300-900 bar for gasoline and diesel fuels. We only need a low pressure gasoline pump (same to port fuel injection or PFI) due to the pressure intensifier (4000). This can significantly improve durability and reduce parasitic loss, it also reduces cost.

Statement A: we propose a fuel injection method, comprising steps of: (a) supplying a fuel injector with multiple low pressure fuels with different viscosities into pressure intensification chambers, (b) using a pressurized fuel with high viscosity from a pressure reservoir to intensify the low viscosity fuels in the intensification chambers through a pressure intensifier having piston surfaces with different sizes with a large surface facing and being driven by the high viscosity, and smaller piston surfaces facing and pressurizing the said low viscosity fuels, (c) direct injecting the intensified low viscosity and high viscosity fuels into combustion chamber through a injection nozzle;

A fuel injection method of “Statement A”, further comprising steps of: supplying a fuel injector with multiple low pressure fuels with different viscosities, cetane numbers, and octane numbers, into pressure intensification chambers, and direct injecting the intensified fuels with different cetane numbers and octane numbers into combustion chamber through a injection nozzle;

A fuel injection method of “Statement A”, further comprising steps of supplying the high viscosity fuel from pressure reservoir into one of the intensification chambers such that the high viscosity fuel being further intensified by itself through the pressure intensifier among other low viscosity fuels;

A fuel injection method of “Statement A”, further comprising steps of spraying fuels with different cetane number and octane number separately and directly into engine combustion chamber.

A fuel injection method of “Statement A”, further comprising steps of supplying high viscosity fuels to lubricate sliding surfaces contacting low viscosity fuels.

A fuel injection method of “Statement A”, wherein the low viscosity fuels are gasoline fuels, and the high viscosity fuel is a type of diesel fuel.

A fuel injection method of “Statement A”, wherein the low viscosity fuels are ethanol fuels, and the high viscosity fuel is a type of diesel fuel.

A fuel injection method of “Statement A”, wherein the low viscosity fuels are liquid natural gas or compressed natural gas fuels, and the high viscosity fuel is a type of diesel fuel.

A fuel injector, comprising, an electronic control valve to control fuel flows from fuel reservoirs, an injection nozzle to spray fuels directly into combustion chamber, an internal pressure intensifier which has piston surfaces with different sizes with a large surface facing and being driven by the high viscosity fuel from pressure reservoir, and smaller piston surfaces facing and pressurizing low viscosity fuels, which has means to intensify fuels with different viscosities, with high viscosity fuel being used to intensify low viscosity fuels to high pressure for direct injection into combustion chamber.

An fuel injector of above statement, further comprising fuel channels inside the injector to separately supply different fuels with different cetane and octane numbers to nozzle tip, and supply high viscosity fuels to lubricate sliding surfaces contacting low viscosity fuels.

A combustion method, comprising steps of, spraying fuels with high octane numbers and high cetane numbers separately and directly into combustion pressure with high injection pressure and late cycle injection, wherein the fuel of high cetane number serves as an ignition improver and ignition trigger to start the combustion of premixed fuels with high octane numbers.

A combustion method, comprising steps of, spraying fuels with high octane numbers greater than 80 and high cetane numbers greater than 50 separately and directly into combustion chamber with high injection pressure greater than 200 bar for low viscosity fuels and late cycle direct injection, wherein the fuel of high cetane number serves as an ignition improver and ignition trigger to start the combustion of premixed fuels with high octane numbers.

The embodiment is focused on a unit fuel injector using gasoline-diesel duel fuel. The same invention disclosed here can be applied to other fuel combinations and common rail injectors, without depart from the scope of the claims disclosed. For example, spring holder (4) can contain a solenoid valve which can have direct control of nozzle needle (2) instead of a passive nozzle driven by fuel pressure. For another example, we can add a second solenoid valve next to 17 to have dedicated control of pressure release from intensifying chamber (21) using a separate passage other than passage 20.

The following sections give a detailed discussion related to embodiments of pressure intensifiers of the fuel injectors of this invention.

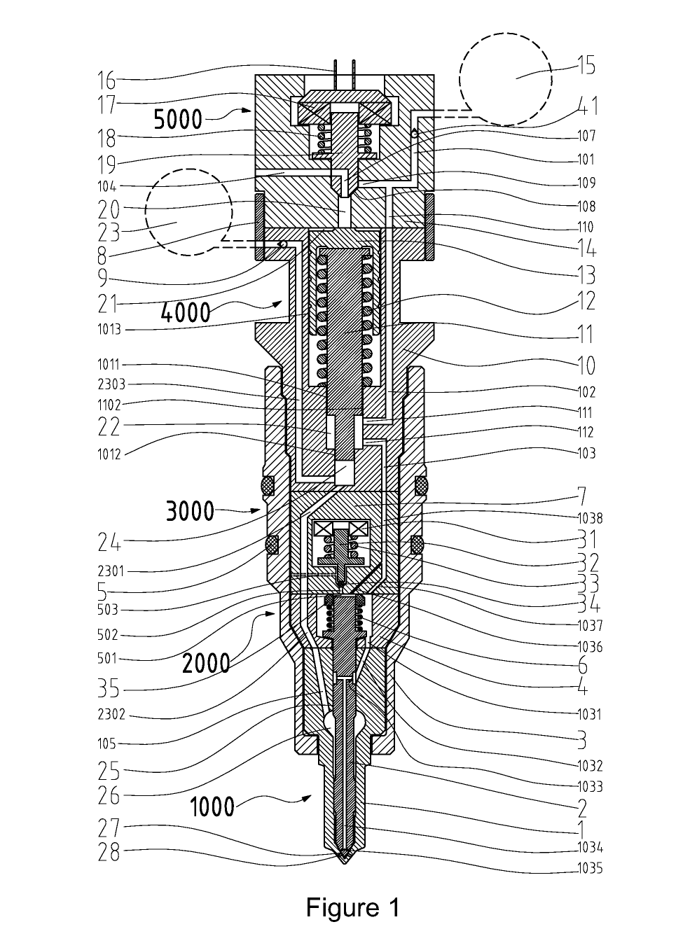

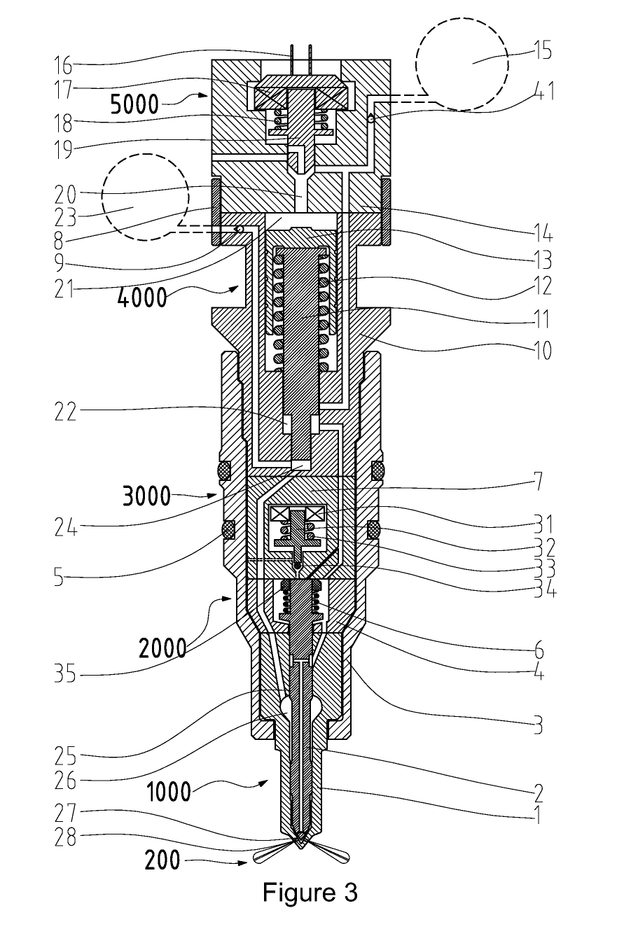

FIG. 4(a) is an illustration of the intensification plunger with different face areas of S1, S2, S3, as contained in the fuel injector illustrated in FIG. 1. For simplicity, the top cylindrical piston with area S1 should be considered as the assembly of the piston (13) and the plunger (11) in FIG. 1-3, and FIG. 6-11. S1, S2 is facing fuel with higher viscosity miu(sub)1, S3 is facing fuel with low viscosity miu (sub)2. In practice, S1 can be greater than S3 for pressure intensification for pressure P3, or make P3 greater than P1. However, if needed, S1 can be smaller than S3 for pressure intensification ratio less than 1, or P3 is less than P1. (b) is an illustration of the intensification plunger with different face and shoulder areas of S1, S2, S3, S4, with two types of fuels with viscosity miu(sub) 1 and miu (sub) 2 being intensified; (c) is an illustration of the intensification plunger with different face and shoulder areas of S1, S2, S3, S4, with three types of fuel bearing viscosity of miu(sub) 1, miu (sub) 2 and miu (sub) 3 being intensified. In practice, S1 can be greater than S2, S3, S4, or P4 is greater than P1. S1 can also be smaller than S2, S3, S4 to produce a pressure intensification ratio less than 1, or P4 is less than P1.

The following sections give a detailed discussion related to needle embodiments of the fuel injectors of this invention.

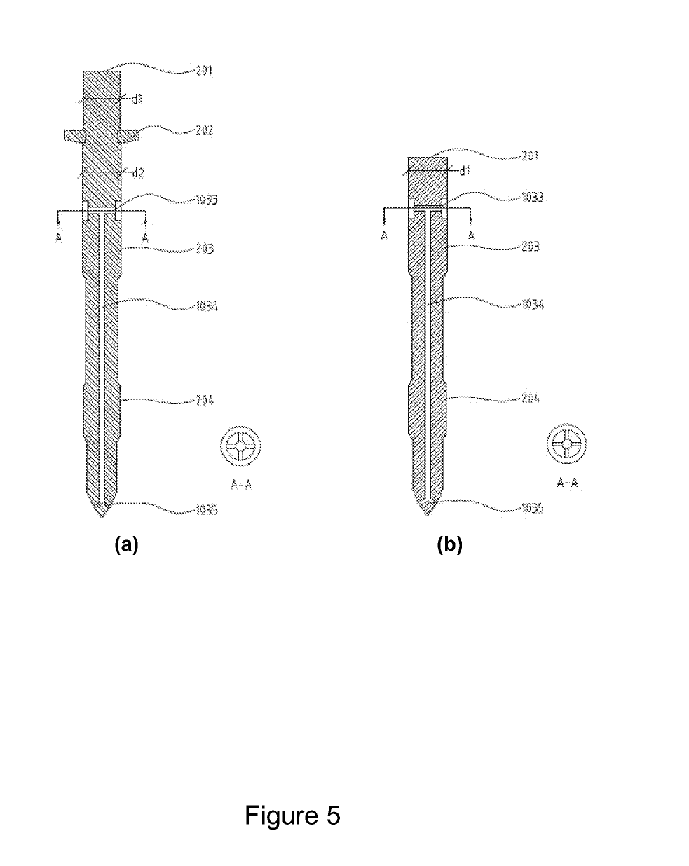

FIG. 5(a) is an illustration of the needle being used for the one type of injector, referred as multi-fuel common rail injector; 202 is the supporting ring, 1033, 1034, 1035 are high pressure fuel passages leading fuel, generally with higher viscosity and cetane number than the fuel surrounding the needle outer surface, to nozzle tip. (b) is an illustration of the needle being used for the one type of injector, referred as multi-fuel unit injector. 1033, 1034, 1035 are high pressure fuel passages leading fuel to nozzle tip. In both (a) and (b), 203, 204 are needle guides. In practice, diameter d1 and d2 can be equal or with one is greater than another.

The following sections give a detailed discussion related to four exemplary embodiments of the fuel injectors of this invention. In the following discussion, we use gasoline to represent low viscosity fuel, use diesel to represent high viscosity fuel. This by no means limiting the applications of the invention. Thus, gasoline can be replaced by ethanol, liquid natural gas (LNG) or other low viscosity fuels. Diesel fuel can be replaced by biodiesel fuels, or even gasoline with lubricity additives.

FIG. 1 is a cross-sectional view of a first exemplary embodiment of an injector of the invention, referred as multi-fuel common rail injector, when the needle is at seating position, no fuel is being injected;

Referring to FIG. 1, low pressure gasoline flows into the fuel injector from a low pressure fuel rail or reservoir (23) through fuel passage (2303) and is filled in the pressure intensification chamber (24). When the solenoid valve (17) for pressure intensifier is not energized, the control valve plunger (19) is closed, pressurized diesel fuel is filled in the diesel intensification chamber (22) through passages (101, 110, 102, 111) and is guided through fuel passages (112, 103, 1038, 1036) to needle lift control chamber (501), through passages (1038, 1037, 1031, 1032, 1033) to needle tip along the fuel passage in needle center (1034) and small needle passage (1035). When needle control valve (31) is not energized, the check valve (34) blocks fuel flow, the needle (2) is at seating position, no fuel is injected.

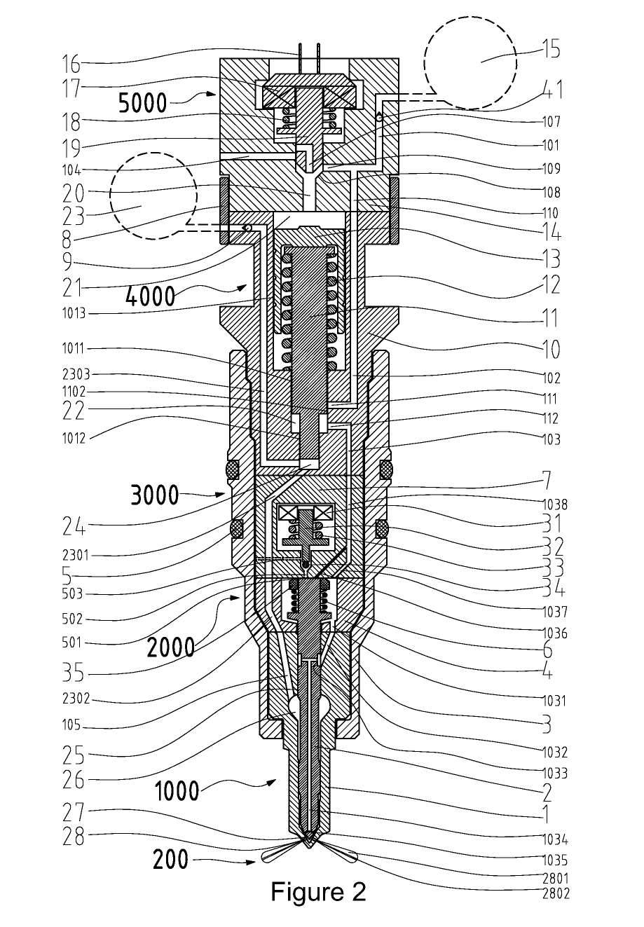

Referring to FIG. 2, when the solenoid valve (17) is energized, the control valve plunger (19) was lifted up, high pressure diesel fuel or other high viscosity fuel from common rail (15) flows into intensifying chamber (21) through fuel passages (101, 109, 20), pressure intensifier piston (13) and intensifier plunger (11) are intensified and are pushed downward quickly, both the gasoline and diesel fuel in the intensification chambers (22, 24) are pressurized. The check valve (9) blocks gasoline backward flow, the gasoline pressure in nozzle chamber raises. And the sliding surface (1101) of plunger (11) blocks the back flow of fuel in chamber 22. The needle control solenoid valve (31) is than energized, the check valve (34) connect the fuel with low pressure reservoir, the nozzle needle (2) is lifted up, fuel injection begins with major gasoline fuel starts first, followed by diesel injection (can be designed vice versa). After metering the desired injection fuel quantity based on pulse-width map, the solenoid valves (31) closes, and pressure in needle control chamber (502) raises. At the same time intensifier control solenoid valve (17) is de-energized, control valve (19) closes. Partial fuel from intensifying chamber (21) flows into low pressure fuel passage (104) through fuel passage (20, 107), the pressure in the intensifying chamber (21) reduces. The pre-pressed plunger spring (12) pushes back the intensifier piston (13) to a stop position. The spring (6) and pressure in needle control chamber on top of nozzle needle (2) conquers the reduced lifting force by pressure in nozzle chamber (25), the needle (2) returns to seat, fuel injection ends. In practice, depending on specific control circuit design, there may be a delay between the closing of intensifier control solenoid (17) and needle control solenoid (31).

The fuel circuit for diesel fuel can be designed such that there is an injection phase delay for diesel fuel than gasoline fuel (vice versa can be done too). In another word, fuel injection starts with major gasoline fuel and ends with fuels containing major diesel fuel. The diesel fuel simultaneously serves as lubricant for the plunger and needle sliding surfaces (1013, 1011, 1012, 25) and needle seat (27), and intensification fuel. This eliminates concerns about the wearing of the nozzle due to low viscosity of gasoline or other low viscosity fuels. This simple lubrication concept is fundamentally important to ensure durability and thus make it viable for the high pressure injection of low viscosity gasoline fuel, which otherwise may not be possible.

By switching the supply line of gasoline and diesel through a 2-way solenoid valve, the multi-fuel injector can be a single fuel injector with fuel injection modulated at different pressure level. By different configurations for the pressure intensifier area ratios as shown in FIG. 4, and materials, the injector can be customized for different dual-fuel/multi-fuel combinations, including gasoline-diesel, ethanol-diesel, ethanol-biodiesel, LNG-diesel, etc. The disclosed injector design is modular and adaptable.

FIG. 6 is a cross-sectional view of a second exemplary embodiment of an injector of the invention, being referred as multi-fuel unit injector, with only one electronic control valve, with needle at lifted position, with fuel being injected. Its operation has been discussed in the beginning of this detailed description section.

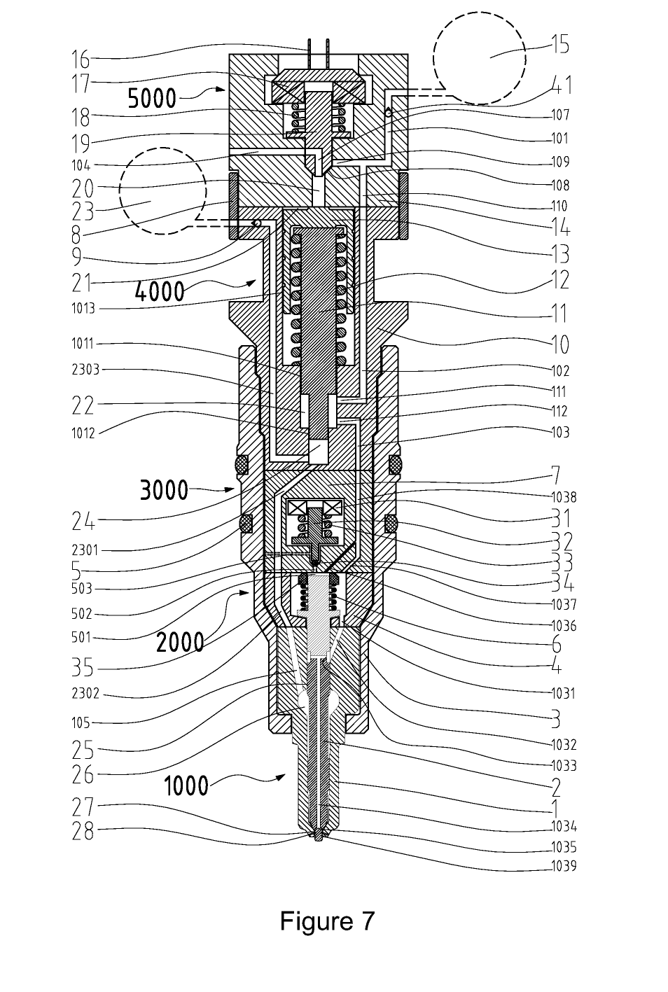

FIG. 7 is a cross-sectional view of a third exemplary embodiment of an injector of the invention, referred as multi-fuel common rail injector with a variable orifice, when the needle is at seating position, no fuel is being injected. The injector in FIG. 7 is same as the injector FIG. 1 except bearing a micro-variable circular orifice (MVCO) nozzle. Thus, the operation of fuel injector in FIG. 7 is the same as the fuel injector in FIG. 1, except the variable spray patterns produced. The MVCO nozzle bears following features. A MVCO nozzle comprising:

(i) a nozzle body (1) comprising passages for fuel, an inner cylindrical space for receiving a needle valve (2), and a conical surface close to the tip of the nozzle body for guiding a spray of fuel;

(ii) a needle valve (2), which has a converging-diverging conical head for guiding a spray of fuel and which is movable back and forth and received in said nozzle body, wherein said needle valve is at a biased closing position with its seal surface (27) being pressed against nozzle body (1) to block fuel flow, or an opening position defined by driving means through lifting the said needle valve seal surface away from nozzle body; and

(iii) a micro-variable-circular-orifice comprising a variable annular ring aperture (1039) between said needle valve and said nozzle body which has means of producing hollow conical spray, and at least one conventional multijet-orifice (28) inside the said nozzle body (1) which has means of producing at least one conventional jet spray, such that fuel is dischargeable in variable sprays of hollow conical and multiple jets shapes through said micro-variable-circular-orifice and multijet-orifice by lifting said needle valve at different magnitudes.

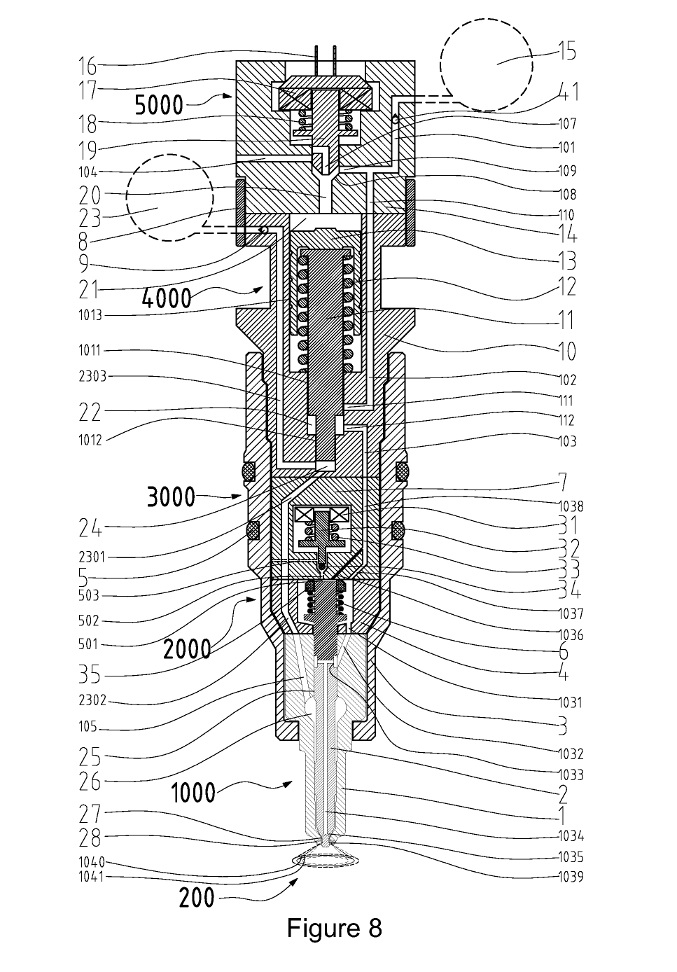

FIG. 8 is a cross-sectional view of a third exemplary embodiment of an injector of the invention, same as FIG. 7, referred as multi-fuel common rail injector with a variable orifice, when the needle is at small lift position, fuel is being injected in hollow conical spray patterns;

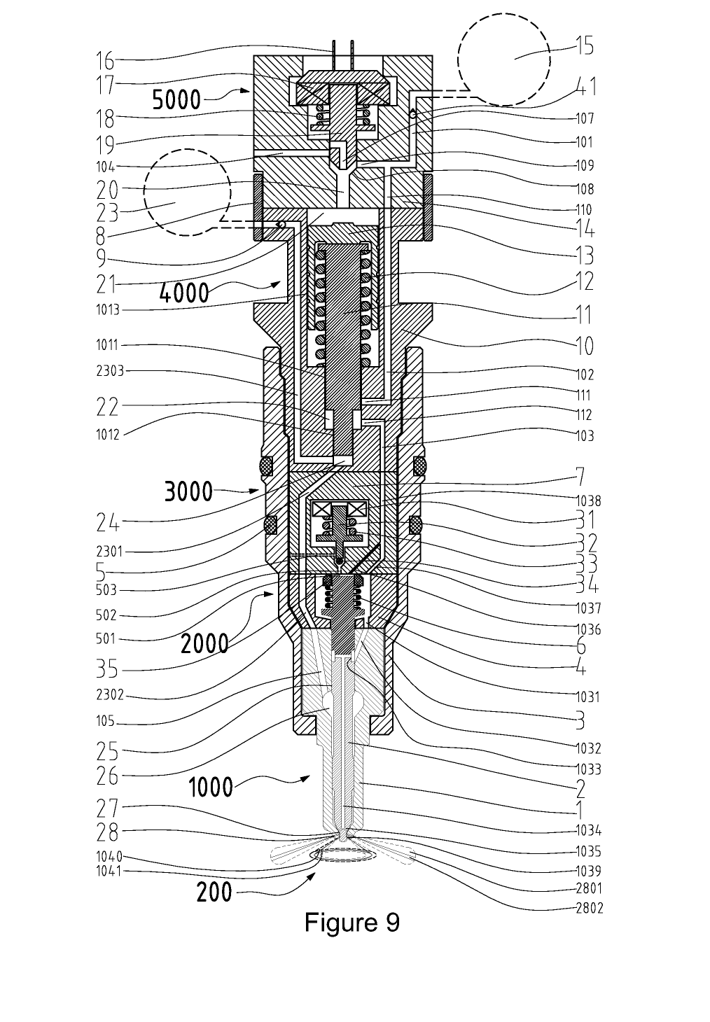

FIG. 9 is a cross-sectional view of a third exemplary embodiment of an injector of the invention, same as FIG. 7, referred as multi-fuel common rail injector with a variable orifice, when the needle is at further lifted position, fuel is being injected in both hollow conical spray patterns and multiple jets;

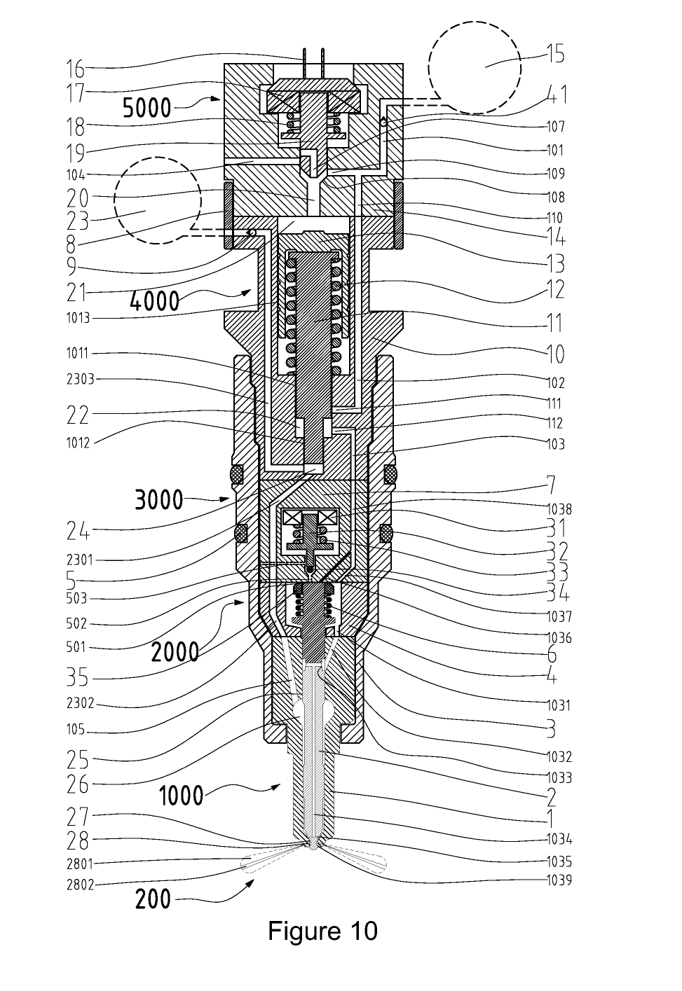

FIG. 10 is a cross-sectional view of a third exemplary embodiment of an injector of the invention, same as FIG. 7, referred as multi-fuel common rail injector with a variable orifice, when the needle is at full lift position, fuel is being injected in multiple jets while hollow conical sprays being blocked;

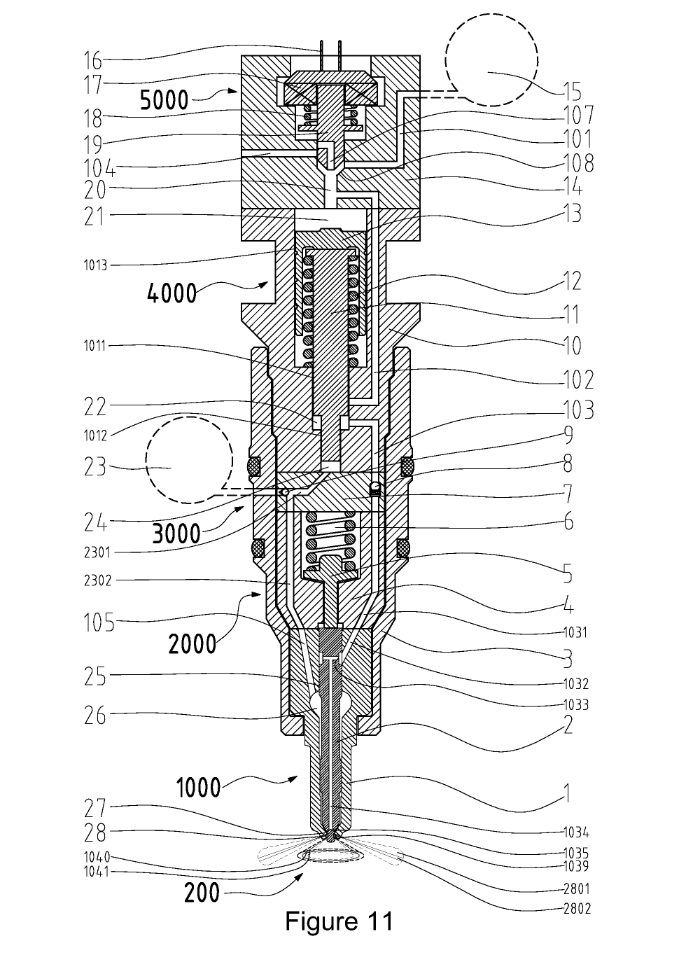

FIG. 11 is a cross-sectional view of a fourth exemplary embodiment of an injector of the invention, referred as multi-fuel unit injector with a variable orifice, when the needle is at further lifted position, fuel is being injected in both hollow conical spray patterns and multiple jets. The operation of the injector in FIG. 11 is the same as the fuel injector in FIG. 6, except the variable orifice nozzle, which is the same as the nozzle in FIG. 7.

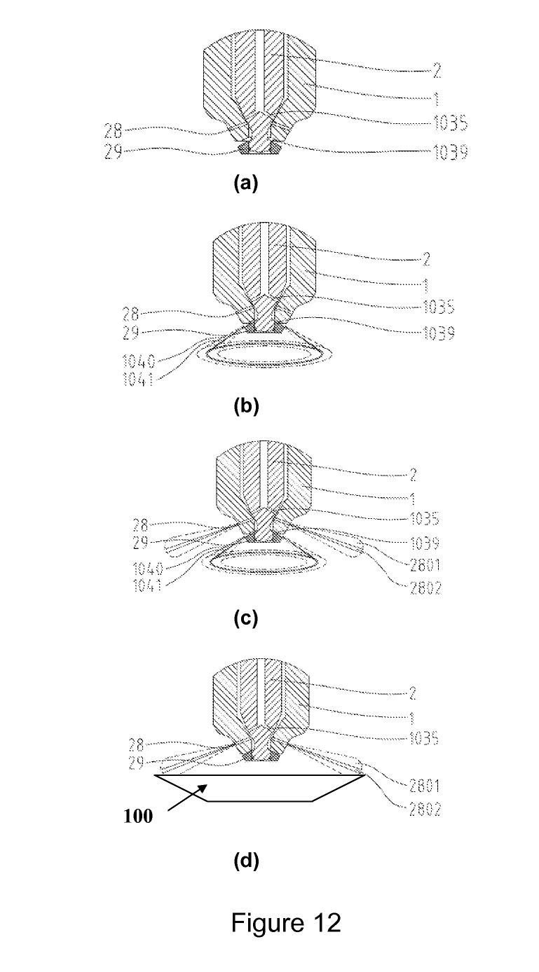

FIG. 12 is a cross-sectional view of a variable orifice nozzle with a needle tip shield for another embodiment of an injector of the invention at different states, (a) needle at seating position, (b) needle at small lift, (c) needle at further lift, (d) needle at full lift. The nozzle is other vise the same as the MVCO nozzle described for FIG. 7, except the nozzle tip. Thus, it can be used to replace the nozzles in the injector as described in FIG. 7 and FIG. 11 to form another two design embodiments.

The examples of embodiments are intended to illustrate the key structures and mechanisms, and should not be considered as limitations of the invention scope. For example, the electronic control valves used for pressure intensifier and needle lift control can be a solenoid valve or a piezoelectric actuator, or any other rapidly switching actuating unit know to those skilled in the art. For another example, the variable orifice nozzle can have a single needle valve as illustrated in FIG. 1, or dual needle valves as illustrated in PCT/US 11/56002. Other type of injection nozzles such as an outward-opening puppet valve nozzle with needle modified to bear internal fuel passages can also be used.

1. A fuel injection method, comprising steps of: (a) supplying a fuel injector with multiple low pressure fuels with different viscosities into pressure intensification chambers, (b) using a pressurized fuel with high viscosity from a pressure reservoir to intensify the low viscosity fuels in the intensification chambers through a pressure intensifier having piston surfaces with different sizes with a large surface facing and being driven by the said high viscosity fuel, and smaller piston surfaces and shoulder surfaces facing and pressurizing the said low viscosity fuels, (c) direct injecting the intensified low viscosity and high viscosity fuels into combustion chamber through a injection nozzle.

2. A fuel injection method of claim 1, further comprising steps of: supplying a fuel injector with multiple low pressure fuels with different viscosities, cetane numbers, and octane numbers, into pressure intensification chambers, and directly injecting the intensified fuels with different cetane numbers and octane numbers into combustion chamber through a injection nozzle.

3. A fuel injection method of claim 1, further comprising steps of supplying the high viscosity fuel from pressure reservoir into one of the intensification chambers such that the high viscosity fuel is also being further intensified by itself through the pressure intensifier among other low viscosity fuels for high pressure direct injection.

4. A fuel injection method of claim 1, further comprising steps of spraying fuels with different cetane number and octane number separately and directly into combustion chamber.

5. A fuel injection method of claim 1, further comprising steps of supplying high viscosity fuels to lubricate sliding surfaces of the fuel injection devices contacting low viscosity fuels.

6. A fuel injection method of claim 1, wherein the low viscosity fuels are gasoline fuels, and the high viscosity fuel is a type of diesel fuels.

7. A fuel injection method of claim 1, wherein the low viscosity fuels are ethanol fuels, and the high viscosity fuel is a type of diesel fuels.

8. A fuel injection method of claim 1, wherein the low viscosity fuels are liquid natural gas, compressed natural gas fuels, and the high viscosity fuel is a type of diesel fuels.

9. A fuel injector, comprising, an electronic control valve to control fuel flows from fuel reservoirs, an injection nozzle to spray fuels directly into combustion chamber, an internal pressure intensifier which has piston surfaces with different sizes with at least one surface facing and being driven by the high viscosity fuel from pressure reservoir, and at least one of the piston surfaces and shoulder surfaces facing and pressurizing low viscosity fuels, which has means to intensify fuels with different viscosities, with high viscosity fuel being used to intensify low viscosity fuels to high pressure for direct injecting into combustion chamber.

10. An fuel injector of claim 9, further comprising fuel passages inside the injector to separately supply different fuels with different cetane numbers and octane numbers to nozzle tip, and supply high viscosity fuels to lubricate sliding surfaces contacting low viscosity fuels.

11. A combustion method, comprising steps of, spraying fuels with high octane numbers and high cetane numbers separately and directly into combustion pressure with high injection pressure and late cycle injection, wherein the fuel of high cetane number serves as an ignition improver and ignition trigger to start the combustion of premixed fuels with high octane numbers.

12. A combustion method of claim 11, comprising steps of, spraying fuels with high octane numbers greater than 80 and high cetane numbers greater than 50 separately and directly into combustion chamber with high injection pressure greater than 200 bar for low viscosity fuels and late cycle direct injection, wherein the fuel of high cetane number serves as an ignition improver and ignition trigger to start the combustion of premixed fuels with high octane numbers.

13. A fuel injector, referred as a multi-fuel common rail injector, comprising: (i) a pressure intensifier, wherein it has means to intensify fuels with different viscosities and cetane numbers, with at least one high viscosity fuel being used to intensify low viscosity fuels to high pressure for directly injecting into combustion chamber, wherein there are multiple pressure intensification chambers and a cylindrical piston comprising different diameters with faces and shoulder surfaces having different sizes, with at least one surface facing and being driven by a high viscosity fuel, and at least one of the other piston faces and shoulder surfaces facing and pressurizing low viscosity fuels, (ii) an electronic control valve to control fuel flows from a pressurized fuel reservoir into an intensifying chamber of the said pressure intensifier and pressurize and depressurize the fuels in the pressure intensifier according to predefined electronic control valve positions, (iii) an injection nozzle to inject fuels directly into engine combustion chamber, (iv) an electronic control valve to control the needle lift of the injection nozzle, (v) fuel passages supplying high viscosity fuels to needle sliding surfaces, (vi) fuel passages within needle to guide fuel to nozzle tip.

14. A fuel injector of claim 13, further comprising a conventional multi-hole nozzle, wherein it has means to directly inject multiple fuels into combustion chamber in multiple jets.

15. A fuel injector of claim 13, further comprising a nozzle with a variable orifice, wherein it has means to directly inject multiple fuels into combustion chamber in different spray patterns including multiple jets and hollow conical sprays, wherein the needle is at seating position, all spray holes are fully covered by the nozzle seal surface and fuel flows are blocked, wherein the needle is at small lift, it has means to inject fuels in hollow conical spray patterns, wherein the needle is at further lift, the nozzle has means to inject fuels in both hollow conical and multiple jet spray patterns, wherein the needle is at full lift, the nozzle has means to inject fuels in multiple jet spray patterns by blocking the hollow conical sprays.

16. A fuel injector, referred as a multi-fuel unit injector, comprising: (i) a pressure intensifier, with at least one high viscosity fuel being used to intensify low viscosity fuels to high pressure for direct injecting into combustion chamber, wherein the pressure intensifier has multiple pressure intensification chambers and a cylindrical piston comprising different diameters with faces and shoulder surfaces having different sizes, with at least one surface facing and being driven by a high viscosity fuel, and at least one of the other piston faces and shoulder surfaces facing and pressurizing low viscosity fuels, (ii) an electronic control valve to control fuel flows from a pressurized fuel reservoir into an intensifying chamber of the said pressure intensifier, pressurize and depressurize the fuels in the pressure intensifier according to predefined control valve positions, (iii) an injection nozzle to inject fuels directly into combustion chamber, (iv) at least one spring to passively control the needle lift of the injection nozzle, (v) fuel passages supplying high viscosity fuels to needle sliding surfaces, (vi) fuel passage within needle to guide a fuel to nozzle tip, wherein it has means of directly injecting fuels with different viscosities and cetane numbers into combustion chamber.

17. A fuel injector of claim 16, further comprising a conventional multi-hole nozzle, wherein it has means of directly injecting multiple fuels into combustion chamber in multiple jets.

18. A fuel injector of claim 16, further comprising a nozzle with a variable orifice, wherein it has means to directly inject multiple fuels into combustion chamber in different spray patterns including multiple jets and hollow conical sprays, wherein the needle is at seating position, all spray holes are fully covered by nozzle seal surface and fuels are blocked, wherein the needle is at small lift, it has means of injecting fuels in hollow conical spray patterns, wherein the needle is at further lift, the nozzle has means of injecting fuels in both hollow conical and multiple jet spray patterns, wherein the needle is at full lift, the nozzle has means of injecting fuels in multiple jet patterns by blocking the hollow conical sprays.

19. A fuel injector of claim 15, further comprising a needle tip shield to reduce needle temperature and guide spray flow.

20. A fuel injector of claim 18, further comprising a needle tip shield to reduce needle temperature and guide spray flow.

21. A fuel injector, comprising, an electronic control valve to control fuel flows from fuel reservoirs, an injection nozzle to spray fuels directly into combustion chamber, an internal pressure intensifier which has piston surfaces with different sizes with at least one surface facing and being driven by one high viscosity fuel from pressure reservoir, and other piston surface and shoulder surfaces facing and pressurizing low viscosity fuels, which has means to intensify fuels with different viscosities, with high viscosity fuel being used to intensify low viscosity fuels to high pressure for direct injecting into combustion chamber, wherein the injection nozzle comprising:
(i) a nozzle body (1) comprising passages for fuel, an inner cylindrical space for receiving a needle valve (2), and a conical surface close to the tip of the nozzle body for guiding a spray of fuel;
(ii) a needle valve (2), which has a converging-diverging conical head for guiding a spray of fuel and which is movable back and forth and received in said nozzle body, wherein said needle valve is at a biased closing position with its seal surface being pressed against nozzle body (1) to block fuel flow, or an opening position defined by driving means through lifting the said needle valve seal surface away from nozzle body; and
(iii) a micro-variable-circular-orifice comprising a variable annular ring aperture (1039) between said needle valve and said nozzle body which has means of producing hollow conical spray, and at least one conventional multijet-orifice (28) inside the said nozzle body (1) which has means of producing at least one conventional jet spray, such that fuel is dischargeable in variable sprays of hollow conical and multiple jets shapes through said micro-variable-circular-orifice and multijet-orifice by lifting said needle valve at different magnitudes.

22. A fuel injector of claim 21, wherein when the nozzle needle (2) is at seating position, both the multijet orifices (28) and fuel passages outlets within the needle (1035) are fully covered by nozzle body sealing surface to fully bock fuel flow of all fuels.

23. A fuel injector of claim 21, further comprising a needle tip shield (29) to reduce needle temperature and guide spray flow.
